(19) United States
(12) Patent Application Publication
(10) Pub. No.: US 2009/0213102 A1
(43) Pub. Date: Aug. 27, 2009

(54) BOOTING METHOD AND SHUTTING DOWN METHOD FOR IMAGE DISPLAY DEVICE

(75) Inventors: Mao-Jung Chung, Tainan County (TW); Yu-Shen Kung, Tainan County (TW); Chin-Cheng Liu, Tainan County (TW)

Correspondence Address: J C PATENTS, INC., 4 VENTURE, SUITE 250, IRVINE, CA, 92618, US

(73) Assignee: HIMAX DISPLAY, INC., Tainan County (TW)

(21) Appl. No.: 12/036,749

(22) Filed: Feb. 25, 2008

(51) Int. Cl. G09G 5/00

(52) U.S. Cl. 345/211

(57) ABSTRACT

During booting of a display panel and a light source, low power supply for electronic circuits is provided to the display panel. Then, the display panel is set by R/W commands. Then, high power supply for liquid crystal transition is provided to the display panel. Then, the display panel is discharged for removing residual electronic charges. Then, the light source is turned on for emitting light to the display panel. On the contrary, during shut down, the light source is turned off and then the display panel is discharged. Then, application of high power supply is stopped. Then, the display panel is set by R/W commands. Then, application of low power supply is stopped.

### BACKGROUND OF THE INVENTION

1. Field of Invention

The present invention relates to power on sequence and/or power off sequence of an image display device.

2. Description of Related Art

Recently, there has been known a front projector that forms a projection image on a front side (a viewer side) of a screen for home use such as home theater system.

The current trend of mobility drives the consumer demand towards ever smaller portable devices, such as mobile phones, portable digital assistants, music and video players, laptop PCs, head mounted displays etc. As the size becomes smaller and the functionality higher, there is a fundamental problem of showing large enough visual images with very small devices. Because the size of a fixed screen cannot grow without increasing the size of the device itself, the only reasonable way to conveniently provide visual images from small devices is to project them using a data projector.

Another issue that is of interest to large audiences in image projection is the issue of 3-dimensional (3D) projection. The current data projectors are not inherently capable of showing full color 3D images and the special devices that are designed to do so are expensive and rare. The media industry increases the offering on 3D movies, games and other entertainment only if 3D capable devices are commonly used.

However, it is preferred to extend lifecycles of the image display device or image projection device. Further, better display result is also preferred. Still further, low power consumption is also needed.

### SUMMARY OF THE INVENTION

The invention provides power on sequence and/or power off sequence for image display device which is capable of extending lifecycles and/or upgrading display performance of the image display device or image projection device, by panel discharge.

Further, the invention provides power on sequence and/or power off sequence for image display device which is capable of providing better display result, by performing panel discharge during disable of light sources.

Still further, the invention provides power on sequence and/or power off sequence for image display device which is capable of achieving low power consumption by performing panel command setting under low power supply.

One example of the invention provides a booting method for a display panel and a light source, applicable in an image display device or an image projection device. The method includes: (a1) providing a first reference voltage to the display panel; (a2) performing a command for setting the display panel; (a3) providing a second reference voltage to the display panel; (a4) discharging the display panel; and (a5) turning on the light source for emitting light to the display panel.

Another example of the invention provides a shutting down method for a display panel and a light source, applicable in an image display device or an image projection device. The method includes: (b1) turning off the light source; (b2) discharge the display panel; (b3) terminating provision of a first reference voltage to the display panel; (b4) performing a command for setting the display panel; and (b5) terminating provision of a second reference voltage to the display panel.

Still another example of the invention provides a method for improving performance of a display panel and a light source, applicable in an image display device or an image projection device. The method includes: (a) during booting of the display panel: (a1) providing a first reference voltage to the display panel; (a2) performing a first command for setting the display panel; (a3) providing a second reference voltage to the display panel; (a4) discharging the display panel; and (a5) turning on the light source for emitting light to the display panel; (b) during shutting down of the display panel: (b1) turning off the light source; (b2) discharge the display panel; (b3) terminating provision of the second reference voltage to the display panel; (b4) performing a second command for setting the display panel; and (b5) terminating provision of the first reference voltage to the display panel.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a simplified diagram for a display device applying embodiment of the invention.

FIG. 2 shows a timing diagram for booting sequence for a display panel and a light source applicable in a display device according to a first embodiment of the invention.

FIG. 3 shows a timing diagram for shutting down sequence for the display panel and the light source according to a second embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

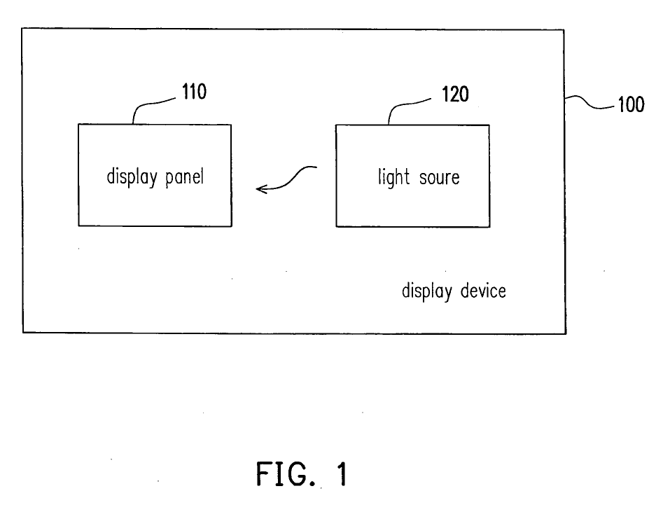

FIG. 1 shows a simplified diagram for a display device applying embodiment of the invention. As shown in FIG. 1, the display device 100 at least includes a display panel 110 and a light source 120. For simplicity, other necessary internal components of the display device 100 are not shown in FIG. 1.

The display device 100 is for example but not limited to a reflective LCoS (Liquid Crystal on Silicon) projector. The display panel 110 is for example but not limited to a reflective LCoS panel or TFT-LCD (thin-film-transistor liquid crystal display) panel. The display panel 110 is used for displaying images. The light source 120 is an active light source, for emitting light onto the display panel 110. The light source 120 includes for example but not limited to, LED (light emitting diode). LED is commonly used as the light source for the display device, because of its properties of reduced power consumption and heat release, decreased dimensions, and extended lifetime.

### First Embodiment

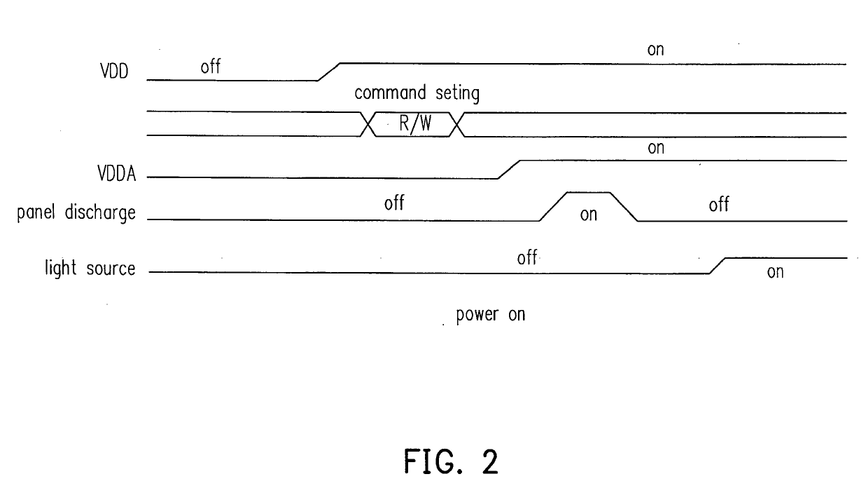

Now please refer to FIG. 2 which shows a timing diagram for booting sequence for a display panel and a light source applicable in a display device according to a first embodiment of the invention.

Now please refer to FIG. 2. First, a low power supply VDD is turned on to be applied to the display panel. Further, the low power supply VDD is to be applied to internal electronic circuits of the display device, for example, gate drivers, source drivers and so on. The low power supply VDD is usually lower than 2V.

Command setting is performed for setting the display panel. The command includes for example but not limited to, LCoS read commands or LCoS write commands, or LCoS read/write commands. Further, the command setting is programmable for different display devices. In the embodiment, because command setting is performed under low power supply, power consumption is saved.

Then, a high power supply VDDA is applied to the display panel. The high power supply VDDA is for operation of liquid crystal material of the display panel. For example, the high power supply VDDA is for liquid crystal transition.

Then, the panel discharge is performed after application of high power supply VDDA. The panel discharge is for discharging residual charges accumulated inside the display panel, for extending lifecycle of the display panel. The accumulation of residual charges may be due to, accidental or improper shunt down of the display device.

Then, the light source is turned on for emitting light to the display panel. In the embodiment, panel discharge operation is performed before turn on of the light source, so that users will not see image frames caused by panel discharge on the display panel.

### Second Embodiment

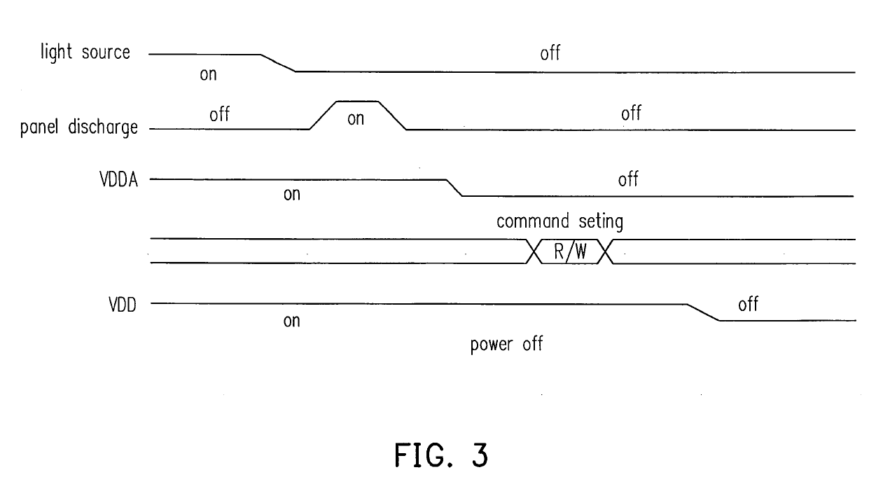

FIG. 3 shows a timing diagram for shutting down sequence for the display panel and the light source according to a second embodiment of the invention.

First, the light source is turned off, so that users will not see image frames caused by the following panel discharge on the display panel.

Then, the display panel is discharged for removing electronic charges accumulated on the display panel during display of the display panel. Then, provision of the high power supply VDDA to the display panel is terminated.

Then, command setting is performed for setting the display panel. The command includes for example but not limited to, LCoS read commands or LCoS write commands, or LCoS read/write commands. Further, the command setting is programmable for different display devices. In the embodiment, because command setting is performed under low power supply, power consumption is saved.

Then, provision of the low power supply VDD to the display panel is terminated.

### Third Embodiment

In a third embodiment, the booting sequence and the shut down sequence for display devices are sequentially performed. Now, please refer to FIG. 2 and FIG. 3 again for explanation of the third embodiment according to the invention.

Now please refer to FIG. 2. First, a low power supply VDD is turned on to be applied to the display panel. Further, the low power supply VDD is to be applied to internal electronic circuits of the display device, for example, gate drivers, source drivers and so on. The low power supply VDD is usually lower than 2V.

Command setting is performed for setting the display panel. The command includes for example but not limited to, LCoS read commands or LCoS write commands, or LCoS read/write commands. Further, the command setting is programmable for different display devices. In the embodiment, because command setting is performed under low power supply, power consumption is saved.

Then, a high power supply VDDA is applied to the display panel. The high power supply VDDA is for operation of liquid crystal material of the display panel. For example, the high power supply VDDA is for liquid crystal transition.

Then, the panel discharge is performed after application of high power supply VDDA. The panel discharge is for discharging residual charges accumulated inside the display panel, for extending lifecycle of the display panel. The accumulation of residual charges may be due to, accidental or improper shunt down of the display device.

Then, the light source is turned on for emitting light to the display panel. In the embodiment, panel discharge operation is performed before turn on of the light source, so that users will not see image frames caused by panel discharge on the display panel.

Now please refer to FIG. 3. The light source is turned off, so that users will not see image frames caused by the following panel discharge on the display panel. Then, the display panel is discharged for removing electronic charges accumulated on the display panel during display of the display panel. Then, provision of the high power supply VDDA to the display panel is terminated. Then, command setting is performed for setting the display panel. The command includes for example but not limited to, LCoS read commands or LCoS write commands, or LCoS read/write commands. Further, the command setting is programmable for different display devices. In the embodiment, because command setting is performed under low power supply, power consumption is further saved. Then, provision of the low power supply VDD to the display panel is terminated.

In the embodiments of the invention, lifecycles of the display device may be extended due to panel discharge for removing residual electronic charged accumulated during operation of display devices or due to accidental or improper shut down of display devices. Further, better display performance is achieved because panel discharge is performed before turn on of light source during booting or after turn off of light source during shutting down. Still further, power consumption is saved because command setting is performed under low power supply.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A booting method for a display panel and a light source, the method comprising:
(a1) providing a first reference voltage to the display panel;
(a2) performing a command for setting the display panel;
(a3) providing a second reference voltage to the display panel;
(a4) discharging the display panel; and
(a5) turning on the light source for emitting light to the display panel.

2. The booting method of claim 1, wherein the second reference voltage is higher than the first reference voltage.

3. The booting method of claim 1, wherein the performing step further comprising:
performing read command setting.

4. The booting method of claim 1, wherein the performing step further comprising:
performing write command setting.

5. The booting method of claim 1, wherein the display panel is an LCoS panel.

6. A shutting down method for a display panel and a light source, the method comprising:
(b1) turning off the light source;
(b2) discharge the display panel;
(b3) terminating provision of a first reference voltage to the display panel;
(b4) performing a command for setting the display panel; and
(b5) terminating provision of a second reference voltage to the display panel.

7. The shutting down method of claim 6, wherein the second reference voltage is lower than the first reference voltage.

8. The shutting down method of claim 6, wherein the performing step further comprising:
performing read command setting.

9. The shutting down method of claim 6, wherein the performing step further comprising:
performing write command setting.

10. The shutting down method of claim 6, wherein the display panel is an LCoS panel.

11. A method for improving performance of a display panel and a light source, the method comprising:
(a) during booting of the display panel:
(a1) providing a first reference voltage to the display panel;
(a2) performing a first command for setting the display panel;
(a3) providing a second reference voltage to the display panel;
(a4) discharging the display panel; and
(a5) turning on the light source for emitting light to the display panel; and
(b) during shutting down of the display panel:
(b1) turning off the light source;
(b2) discharge the display panel;
(b3) terminating provision of the second reference voltage to the display panel;
(b4) performing a second command for setting the display panel; and
(b5) terminating provision of the first reference voltage to the display panel.

12. The method of claim 11, wherein the second reference voltage is higher than the first reference voltage.

13. The method of claim 11, wherein the step (a2) includes:
performing read command setting.

14. The method of claim 11, wherein the step (a2) further includes:
performing write command setting.

15. The method of claim 11, wherein the step (b4) includes:
performing read command setting.

16. The method of claim 11, wherein the step (b4) further includes:
performing write command setting.
